(19) United States
(12) Patent Application Publication
(10) Pub. No.: US 2020/0137376 A1
(43) Pub. Date: Apr. 30, 2020

(54) METHOD FOR GENERATING A LIGHT-FIELD 3D DISPLAY UNIT IMAGE AND A GENERATING DEVICE

(71) Applicant: Wuhan China Star Optoelectronics Technology Co., Ltd, Wuhan, Hubei (CN)

(72) Inventor: Zefang DENG, Wuhan, Hubei (CN)

(21) Appl. No.: 15/579,039

(22) PCT Filed: Nov. 14, 2017
(86) PCT No.: PCT/CN2017/110928

§ 371 Date: Aug. 14, 2018

(30) Foreign Application Priority Data
Oct. 31, 2017 (CN) 201711043061.6

(51) Int. Cl. H04N 13/305

(52) U.S. Cl. CPC H04N 13/305

(57) ABSTRACT

A method for generating a light-field 3D display unit image is provided, including: acquiring a two-dimensional left eye and right eye images of an original image, offering a depth information and a depth image of which and selecting either of which as a basic image, slicing a depth image corresponding to the basic image in a depth direction to obtain in different depth directions, establishing a virtual scene, generating a virtual recording device and a virtual micro-lens array, recording slice images by the device after the micro-lens array to obtain a corresponding number of recording images, superimposing recording images, and obtaining a unit image. The disclosure further provides a generating device, including: an image acquisition module, a depth information calculation module, an image processing module, a scene creation module and a virtual recording device. Compared with the prior art, not only simplifies the process but saves cost.

### RELATED APPLICATIONS

The present application is a National Phase of International Application Number PCT/CN2017/110928, filed Nov. 14, 2017, and claims the priority of China Application No. 201711043061.6, filed Oct. 31, 2017.

### FIELD OF THE DISCLOSURE

The disclosure relates to a display technical field, and more particularly to a method for generating a light-field 3D display unit image and a generating device.

### BACKGROUND

A light-field 3D display is one of important technologies of 3D naked-eye display, which is based on a micro-lens array of a true three-dimensional display technology including the two processes of three-dimensional scene acquisition and reproduction. A whole acquiring system structure is sequentially a three-dimensional scene, the micro-lens array, a recording device of a recording equipment (a two-dimensional image sensing device such as a CCD or a CMOS) (shown in FIG. 1). The light emitted from the three-dimensional space scene is recorded by the recording device in different perspective images after passing through the micro-lens array. Each micro-lens unit acquires a part of the different directions of spatial three-dimensional scene, and a two-dimensional perspective image at this angle is after recorded by the recording device of the recording equipment. The two-dimensional image is a unit image. Each micro-lens corresponds to a unit image, which a large number of unit images together form a unit image array, and the spatial information of the entire three-dimensional scene are saved as the unit image. Reproducing process is a reverse of the recording process (shown in FIG. 2), which uses the micro-lens array to converge the light transmitted from the unit image to reproduce the recorded three-dimensional scene to achieve the true three-dimensional display.

In the light-field 3D display, the acquisition of the unit image is a very important part. In present, the unit image is acquired by a camera-array structure, which the structure is composed of two or more cameras with a same physical parameter according to a certain arrangement, and in the process of shooting all cameras must ensure a synchronized shooting. Adopting this method to acquire the unit image needs a complicated structure and equipment, a harsh condition is required with high cost. In addition, due to limitation of the camera itself, the number of the unit image acquired for the same scene will be relatively small, which is difficult to meet the purpose of a high-definition three-dimensional display.

### SUMMARY

To overcome the insufficiency of the present technique, a disclosure provides a method for generating a light-field 3D display unit image and a generating device, which acquires a unit image for a three-dimensional scene by a virtual manner, meeting the purpose of a high-definition three-dimensional display and saving cost.

The present disclosure provides a method for generating a light-field 3D display unit image, comprising the following steps:

Acquiring an original image of two-dimensional left eye and right eye images.

Acquiring a depth information and a depth image of the two-dimensional left eye and right eye images.

Selecting the two-dimensional left-eye image or the two-dimensional right-eye images as a basic image, slicing the depth image corresponding to the basic image in a depth direction to obtain N slice images of the basic image in different depth directions.

Establishing an acquisition scene of a virtual three-dimensional scene unit image, and generating a virtual recording device and a virtual micro-lens array.

Recording the N slice images by the virtual recording device after the virtual micro-lens array to obtain a corresponding number of recording images.

Superimposing the recording images, and obtaining a three-dimensional scene unit image of the original image.

Further, slicing the depth image corresponding to the basic image in a depth direction is specifically to acquire a maximum depth value d of a depth information corresponding to the basic image, to set a depth slicing range value d₁, and to acquire one slice image corresponding to the depth value at intervals of each depth slice range value from an initial position of the depth information.

Further, the d₁ is not greater than d.

Further, when recording the N slice images by the virtual recording device after the virtual micro-lens array, a distance from the N slice images to the spatial location of the virtual micro-lens array is the same as the depth value of the N slice images.

Further, the virtual recording device is located at a focal plane position of the virtual micro-lens array.

Further, superimposing the recording images is specifically superimposing the recording images in a same plane.

Further, acquiring an original image of two-dimensional left eye and right eye images is specifically obtained by photographing the original image by two cameras to obtain the original image of two-dimensional left eye and right eye images.

The present disclosure further provides the method for generating a light-field 3D display unit image, wherein the generating device comprising:

An image acquisition module applied to acquire an original image of two-dimensional left eye and right eye images.

A depth information calculation module applied to acquire a depth information and a depth image of two-dimensional left eye and right eye images.

An image processing module applied to select the two-dimensional left-eye image or the two-dimensional right-eye image as a basic image, slicing the depth image corresponding to the basic image in a depth direction to obtain N slice images of the basic image in different depth directions; superimposing the recording images, and obtaining a three-dimensional scene unit image of the original images.

A scene creation module applied to establish an acquisition scene of virtual 3D scene unit image to generate a virtual recording device and a virtual micro-lens array.

The virtual recording device is used to record the N slice images by the virtual recording device after the virtual micro-lens array to obtain a corresponding number of recording images.

Further, slicing the depth image corresponding to the basic image in the depth direction is specifically to acquire a maximum depth value d of the depth information corresponding to the basic image, to set the depth slicing range value d₁, and to acquire one slice image corresponding to the depth value at intervals of each depth slice range value from an initial position of the depth information.

Further, superimposing the recording images is specifically superimposing the recording images in the same plane.

Compared with the prior art, the present disclosure acquires the two-dimensional left and right eye images of the original image, offers the depth information and the depth image of the two-dimensional left and right eye images, slices the depth image corresponding to the basic image in a depth direction to obtain N slice images of the basic image in different depth directions, establishes a virtual three-dimensional scene unit image acquisition scene, generates a virtual recording device and a virtual micro-lens array, recording the N slice images by the virtual recording device after the virtual micro-lens array to obtain a corresponding number of recording images, superimposing the recording images, and obtaining a three-dimensional scene unit image of the original images. The present disclosure is not through a complex camera-array structure but through establish the acquisition scene of the three-dimensional scene unit image. In an analogous way, an existing three-dimensional scene acquisition method is transformed into a computer simulation, so that the two-dimensional image is transformed into the three-dimensional unit image of the scene, which not only simplifies the process but also saves the cost.

### BRIEF DESCRIPTION OF THE DRAWINGS

FIG. 1 is a recording schematic diagram of a light-field 3D display;

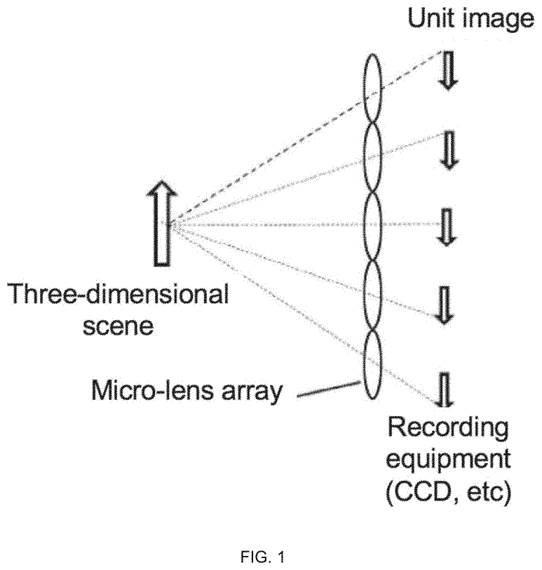

FIG. 2 is a schematic diagram showing a reproduction process of a light-field 3D display;

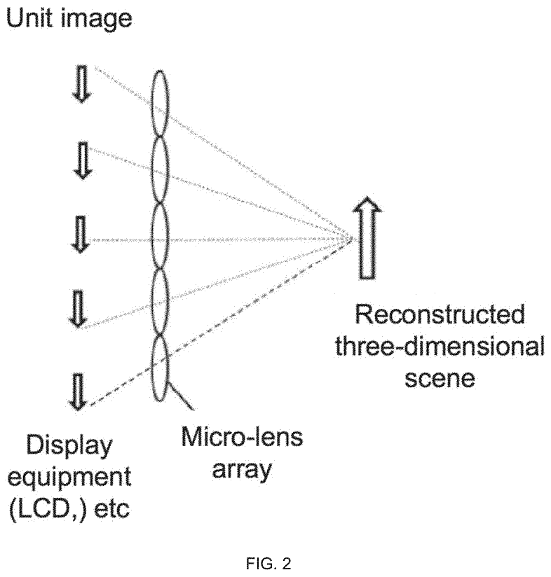

FIG. 3 is a flow chart of a generating method according to the present disclosure;

FIG. 4 is a depth image calculated from left eye and right eye views by a SAD algorithm;

FIG. 5 is an array diagram of slices of an original image;

FIG. 6 is a schematic diagram of simulating an acquisition scene of three-dimensional scene unit image;

FIG. 7 is a schematic diagram of superimposed unit images;

FIG. 8 is a structural schematic view of a generating device according to the present disclosure.

### DETAILED DESCRIPTION OF PREFERRED EMBODIMENTS

A disclosure will be further described in detail following with reference to the accompanying figures and embodiments.

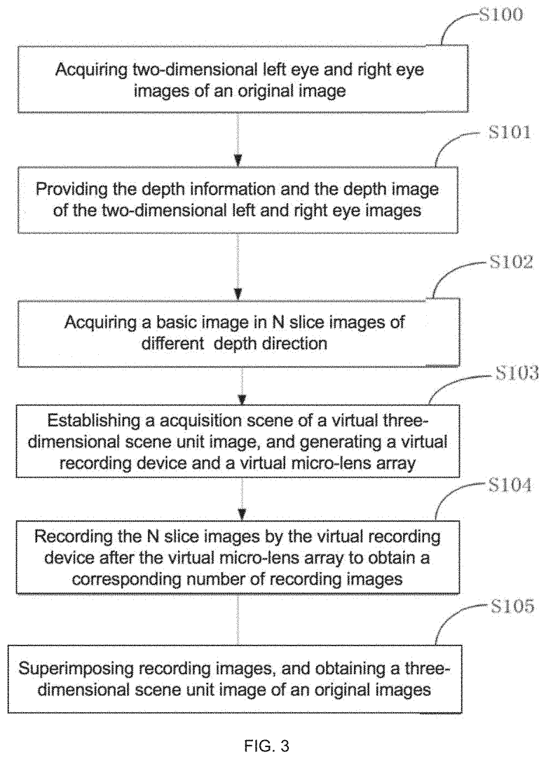

As FIG. 3 shown, a method for generating a light-field 3D display unit image, comprising the following steps:

S100, acquiring an original image of two-dimensional left eye and right eye images; specifically, the original image of two-dimensional left eye and right eye images is acquired by a way of direct shooting with two cameras for the original image.

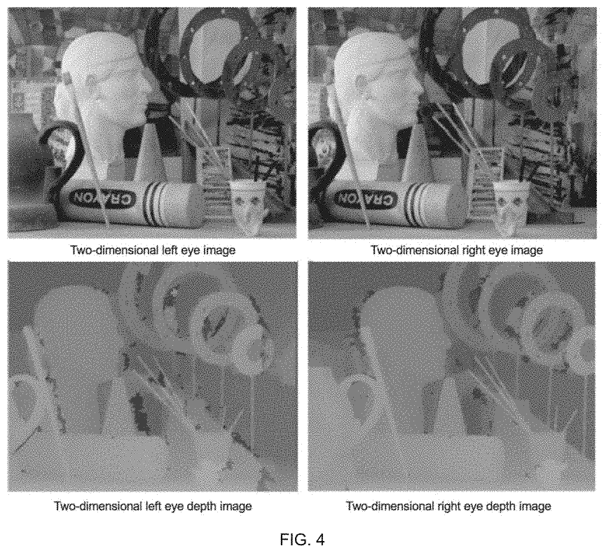

S101, acquiring a depth information and a depth image of the two-dimensional left eye and right eye images; specifically, using a depth processing algorithm to acquire the depth information of the scene of the image from the two-dimensional left eye and right eye images, wherein the depth processing algorithm employs a global or local algorithm, such as a SAD (Sum of absolute differences) matching algorithm, a DP dynamic matching algorithm, an image cutting algorithm, and so on. When using the SAD matching algorithm, the similarity between the two-dimensional left eye and right eye images is evaluated according to a summation of the absolute values of the pixel value differences corresponding to the two-dimensional left eye and right eye images, and the depth information is calculated. After calculating the depth information and after the depth image information is further optimized by bilateral filtering and consistency detection, the depth image corresponding to the left eye and right eye images as shown in FIG. 4 can be obtained.

S102, selecting the two-dimensional left-eye image or the two-dimensional right-eye images as a basic image, slicing the depth image corresponding to the basic image in a depth direction to obtain N slice images of the basic image in different depth directions; specifically, acquiring a maximum depth value d of the depth information (a default minimum depth is 0), and setting a depth slicing range value d₁, which the d₁ is not greater than the d. Acquiring one slice image corresponding to the depth value from an initial position (that is 0) of the depth information at intervals of each depth slice range value, for example, if the maximum depth value of the depth information is 100 and the depth slice range value is set as 10, from the initial position of the depth information, each other depth slice range value, that is to say the depth value of the first slice image is 10, and then spaces an interval of the depth slice range value, that is to say, the depth value of the second slice image is 20, and so on. Therefore, acquiring N slice images.

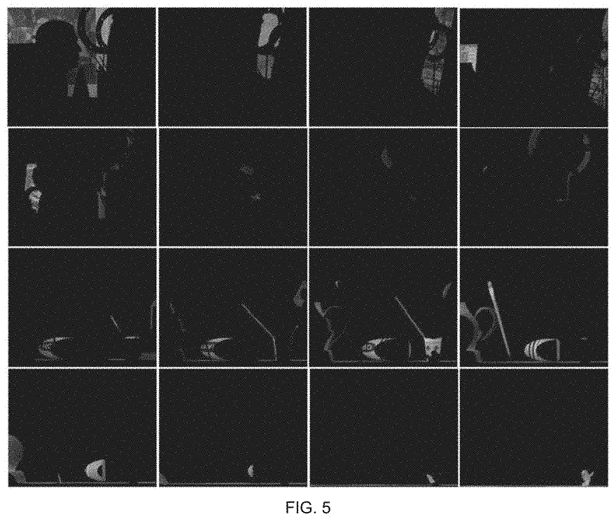

The depth values in the depth slicing range value d₁ are considered to be the same depth, if each interval d₁ is regarded as the same depth from the initial position of 0, therefore, the original image can be cut into N slice images in the depth direction (shown in FIG. 5). Wherein, N=x, x=d/d₁, N is the smallest integer value greater than x. Shown in FIG. 5 is an array diagram of slicing image.

S103, establish an acquisition scene of the virtual three-dimensional scene unit image, and generating a virtual recording device and a virtual micro-lens array. The disclosure saves the establishment cost of a real scene by simulating the acquisition scene of the virtual three-dimensional scene unit image through a computer in a virtual reality manner to acquire a scene;

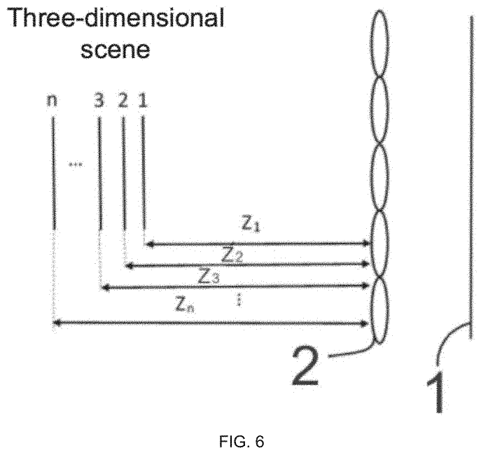

S104, 1 to N slice images on the virtual micro-lens array 2 are recorded by the virtual recording device and a corresponding number of recorded images are obtained (shown in FIG. 6); specifically, when 1 to N slice images on the virtual micro-lens array 2 are recorded by the virtual recording device, a distance from the N slice images to the spatial location of the virtual micro-lens array 2 is the same as the depth value of the N slice images. For example, if there are N slice images, the distances from the spatial location of the N slice images to the virtual micro-lens array 2 are Z₁, Z₂, Z₃ . . . Zₙ (shown in FIG. 6). It should be noted here that the values of Z₁, Z₂, Z₃ . . . Zₙ are the same as the depth values corresponding to N slice images, that is to say, if the depth value of the first slice image is 10, therefore, the value of the distance from the spatial location of the first slice image to the virtual micro-lens array 2 is also 10, which the value n is the same as the N. In this way, we can get a more realistic scene restoration.

In the step of S104, the virtual recording device 1 is located at the focal plane position of the virtual micro-lens array 2.

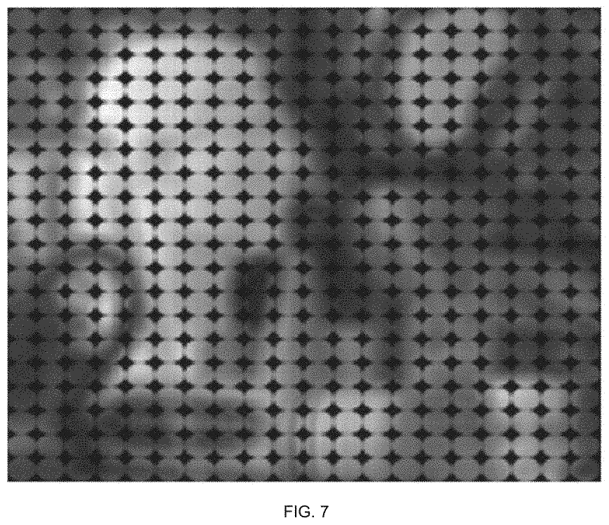

S105, superimposes the recording images and acquires the original image of a three-dimensional scene unit image of (shown in FIG. 7). Specifically, superimposes the recording images in a same plane. The unit image can be used as a raw data in the process of the display, after being displayed the display equipment, the unit image is spatially reconstructed using the micro-lens array having the same parameters as those of the virtual micro-lens array 2 during recording to achieve a true three-dimensional display.

The whole process above does not need any an optical recording hardware device, and the unit image of a light-field data can be recorded by the image acquisition of the left eye and right eye only through using the method of the computer to construct the scene and calculate.

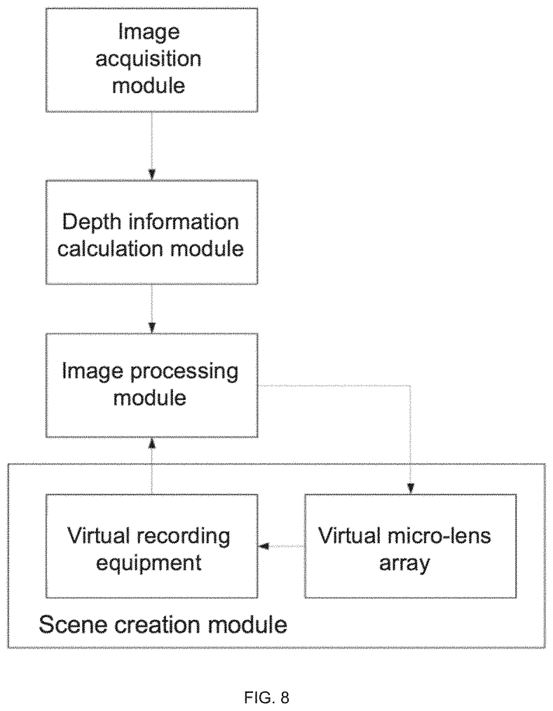

As FIG. 8 shown, a method for generating a light-field 3D display unit image, including:

An image acquisition module applied is used to acquire the original image of two-dimensional left eye and right eye images; and the two-dimensional left eye and right eye images are sent to the depth information to calculate a module and an image processing module processes the module;

A depth information calculation module applied is used to acquire the depth information and the depth image of the two-dimensional left eye and right eye images; and the depth information calculates module and the depth information and the depth image sends to the image processing module;

The image processing module applied to select the two-dimensional left-eye image or the two-dimensional right-eye image as a basic image, slicing the depth image corresponding to the basic image in a depth direction to obtain N slice images of the basic image in different depth directions; superimposing the recording images, and obtaining a three-dimensional scene unit image of the original images;

A scene creation module applied to establish an acquisition scene of virtual 3D scene unit image to generate a virtual recording device and a virtual micro-lens array; and the scene creation module is also used to place the slice image behind the virtual micro-lens array so that the virtual recording device can record;

The virtual recording device is used to record the N slice images by the virtual recording device after the virtual micro-lens array to obtain a corresponding number of recording images; and the virtual recording device sends the recording image to the image processing module;

The virtual micro-lens array is used to simulate the real micro-lens array to obtain a multi-directional perspective;

The image processing module slices the depth image corresponding to the basic image in a depth direction to obtain N slice images of the basic image in different depth directions; specifically, acquiring the maximum depth value d of the depth information (a default minimum depth is 0), and setting a depth slicing range value d₁, which the d₁ is not greater than the d. Acquiring one slice image corresponding to the depth value from the initial position (that is 0) of the depth information at intervals of each depth slice range value, for example, if the maximum depth value of the depth information is 100 and the depth slice range value is set as 10, from the initial position of the depth information, each other depth slice range value, that is to say the depth value of the first slice image is 10, and then spaces an interval of the depth slice range value, that is to say, the depth value of the second slice image is 20, and so on. Therefore, acquiring N slice images.

The depth values in the depth slicing range value d₁ are considered to be the same depth, if each interval d₁ is regarded as the same depth from the initial position of 0, therefore, the original image can be cut into N slice images in the depth direction (shown in FIG. 5), Wherein, N=x, x=d/d₁, N is the smallest integer value greater than x.

When the N slice images on the virtual micro-lens array 2 are recorded by the virtual recording device 1, the distance from the N slice images to the spatial location of the virtual micro-lens array 2 is the same as the depth value of the N slice images. For example, if there are N slice images, the distances from the spatial location of the N slice images to the virtual micro-lens array 2 are Z₁, Z₂, Z₃ . . . Zₙ (shown in FIG. 6). It should be noted here that the values of Z₁, Z₂, Z₃ . . . Zₙ are the same as the depth values corresponding to N slice images, that is to say, if the depth value of the first slice image is 10, therefore, the value of the distance from the spatial location of the first slice image to the virtual micro-lens array 2 is also 10, which the value n is the same as the N. In this way, we can get a more realistic scene restoration.

The virtual recording device is located at the focal plane position of the virtual micro-lens array.

The image processing module superimposes the recording images, specifically, superimposes the recording images in a same plane.

With reference to the generating method and the generating device of the disclosure, the generating method of the disclosure will be further described below:

S100, the image acquisition module applied is used to acquire the original image of two-dimensional left eye and right eye images; and the two-dimensional left eye and right eye images are sent to the depth information to calculate a module and the image processing module processes the module,

S101, the depth information calculation module applied is used to acquire the depth information and the depth image of the two-dimensional left eye and right eye images; and the depth information calculates module and the depth information and the depth image sends to the image processing module.

S102, the image processing module applied is used to select the two-dimensional left-eye images and two-dimensional right-eye images as a basic image, slicing the depth image corresponding to the basic image to slice in a depth direction to obtain N slice images of the basic image in different depth directions.

S103, the scene creation module applied is used to establish the acquisition scene of the virtual three-dimensional scene unit image, and to generate the virtual recording device and the virtual micro-lens array; and the scene creation module is also used to place the slice image behind the virtual micro-lens array so that the virtual recording device can record;

S104, the virtual recording device is used to record the N slice images by the virtual recording device after the virtual micro-lens array to obtain a corresponding number of recording images (shown as FIG. 6); and sending the recording image to the image processing module;

S105, the image processing module superimposes the recording image to acquire the original image of the unit image of the three-dimensional.

Although the disclosure has been shown and described in conjunction with specific embodiments, it will be understood by those skilled in the art that various changes in form and combination may be made therein without departing from the spirit and scope of the disclosure as defined by an appended claim and its equivalents.

What is claimed is:

1. A method for generating a light-field 3D display unit image, comprising the following steps:
acquiring an original image of two-dimensional left eye and right eye images;
acquiring a depth information and a depth image of the two-dimensional left eye and right eye images;
selecting the two-dimensional left-eye image or the two-dimensional right-eye images as a basic image, slicing the depth image corresponding to the basic image in a depth direction to obtain N slice images of the basic image in different depth directions;
establishing an acquisition scene of virtual 3D scene unit image, and generating a virtual recording device and a virtual micro-lens array;
recording the N slice images by the virtual recording device after the virtual micro-lens array to obtain a corresponding number of recording images; and
superimposing the recording images, and obtaining a three-dimensional scene unit image of the original image.

2. The method for generating a light-field 3D display unit image according to claim 1, wherein slicing the depth image corresponding to the basic image in a depth direction is specifically to acquire a maximum depth value d of a depth information corresponding to the basic image, and to set a depth slicing range value d₁, and to acquire one slice image corresponding to the depth value at intervals of each depth slice range value from an initial position of the depth information.

3. The method for generating a light-field 3D display unit image according to claim 2, wherein the d₁ is not greater than d.

4. The method for generating a light-field 3D display unit image according to claim 1, wherein when recording the N slice images by the virtual recording device after the virtual micro-lens array, a distance from the N slice images to the spatial location of the virtual micro-lens array is the same as the depth value of the N slice images.

5. The method for generating a light-field 3D display unit image according to claim 1, wherein the virtual recording device is located at a focal plane position of the virtual micro-lens array.

6. The method for generating a light-field 3D display unit image according to claim 2, wherein the virtual recording device is located at the focal plane position of the virtual micro-lens array.

7. The method for generating a light-field 3D display unit image according to claim 3, wherein the virtual recording device is located at the focal plane position of the virtual micro-lens array.

8. The method for generating a light-field 3D display unit image according to any one method of claim 4, wherein the virtual recording device is located at the focal plane position of the virtual micro-lens array.

9. The method for generating a light-field 3D display unit image according to claim 1, wherein superimposing the recording images is specifically superimposing the recording images in a same plane.

10. The method for generating a light-field 3D display unit image according to claim 2, wherein superimposing the recording images is specifically superimposing the recording images in the same plane.

11. The method for generating a light-field 3D display unit image according to claim 3, wherein superimposing the recording images is specifically superimposing the recording images in the same plane.

12. The method for generating a light-field 3D display unit image according to claim 4, wherein superimposing the recording images is specifically superimposing the recording images in the same plane.

13. The method for generating a light-field 3D display unit image according to claim 1, wherein acquiring an original image of two-dimensional left eye and right eye images is specifically obtained by photographing the original image by two cameras to obtain the original image of two-dimensional left eye and right eye images.

14. The method for generating a light-field 3D display unit image according to claim 2, wherein acquiring the original image of two-dimensional left eye and right eye images is specifically obtained by photographing the original image by two cameras to obtain the original image of two-dimensional left eye and right eye images.

15. The method for generating a light-field 3D display unit image light-field according to claim 3, wherein acquiring the original image of two-dimensional left eye and right eye images is specifically obtained by photographing the original image by two cameras to obtain the original image of two-dimensional left eye and right eye images.

16. The method for generating a light-field 3D display unit image according to claim 4, wherein acquiring the original image of two-dimensional left eye and right eye images is specifically obtained by photographing the original image by two cameras to obtain the original image of two-dimensional left eye and right eye images.

17. A generating device of a light-field 3D display unit image, wherein the generating device comprising:
an image acquisition module applied to acquire an original image of two-dimensional left eye and right eye images;
a depth information calculation module applied to acquire a depth information and a depth image of two-dimensional left eye and right eye images;
an image processing module applied to select the two-dimensional left-eye image or the two-dimensional right-eye image as a basic image, slicing the depth image corresponding to the basic image in a depth direction to obtain N slice images of the basic image in different depth directions; superimposing the recording images, and obtaining a three-dimensional scene unit image of the original images; and
a scene creation module applied to establish an acquisition scene of virtual 3D scene unit image to generate a virtual recording device and a virtual micro-lens array;
wherein the virtual recording device is used to record the N slice images after the virtual micro-lens array to obtain a corresponding number of recording image.

18. The generating device of a light-field 3D display unit image according to claim 17, wherein slicing the depth image corresponding to the basic image in the depth direction is specifically to acquire a maximum depth value d of the depth information corresponding to the basic image, to set the depth slicing range value d₁, and to acquire one slice image corresponding to the depth value at intervals of each depth slice range value from an initial position of the depth information.

19. The generating device of a light-field 3D display unit image according to claim 17, wherein superimposing the recording images is specifically superimposing the recording images in the same plane.

20. The generating device of a light-field 3D display unit image according to claim 18, wherein superimposing the recording images is specifically superimposing the recording images in the same plane.
